(19) United States
(12) Patent Application Publication
(10) Pub. No.: US 2026/0273677 A1
(43) Pub. Date: Sep. 17, 2026

(54) HIGH-RIGIDITY TURNING AND MILLING COMPOUND POWER TOOL SPINDLE STRUCTURE

(71) Applicant: DALIAN UNIVERSITY OF TECHNOLOGY, Dalian (CN)

(72) Inventors: Qingkai JIANG, Dalian (CN); Hongwei SUN, Dalian (CN); Zhi WANG, Dalian (CN); Fuyan SUN, Dalian (CN); Jiali ZHANG, Dalian (CN)

(21) Appl. No.: 19/400,966

(22) Filed: Nov. 25, 2025

(30) Foreign Application Priority Data
Oct. 27, 2025 (CN) 202511539290.1

(51) Int. Cl. B23Q 1/70; B23Q 17/22

(52) U.S. Cl. CPC B23Q 1/70; B23Q 17/22

(57) ABSTRACT

The present invention belongs to the field of power spindles for CNC machine tools, and discloses a high-rigidity turning and milling compound power tool spindle structure. The high-rigidity turning and milling compound power tool spindle structure uses a CAPTO standard tool interface, which can achieve high-rigidity connection between a tool and a spindle, and is very suitable for both turning and milling operating modes. A condition monitoring method for the high-rigidity turning and milling compound power tool spindle structure comprises two parts: measuring a non-contact axial position change of a mechanical labyrinth flange that rotates together with the spindle by a distance sensor; and measuring an axial thermal displacement of a mounting part of the distance sensor by a contact displacement sensor and a thermal elongation detection rod. Real-time monitoring of spindle thermal elongation, bearing operating condition, cutting vibration and unexpected collision are achieved by embedding a variety of sensors.

### TECHNICAL FIELD

The present invention belongs to the field of power spindles for CNC machine tools, and relates to a high-rigidity turning and milling compound power tool spindle structure.

### BACKGROUND

Turning and milling compound machining is one of the development directions of high-end CNC machine tools. Horizontal turning and milling compound machining center with slant beds and inclined Y-axis structures have become the mainstream of medium- and large-sized heavy cutting horizontal turning and milling compound machining due to excellent structural rigidity and small floor space, tool power spindles are core components of machine tools, and the requirements for the comprehensive performance of the tool power spindles are extremely high. In addition to the complete milling spindle function, when switched to the turning process, the tool spindles must achieve rigid locking to ensure that the tool tips do not undergo sudden changes under the action of a cutting force, and to achieve good surface quality and dimensional accuracy of workpieces. The conical tool holder interface commonly used in the existing tool spindles cannot fully meet the above requirements in principle. The spindles experience thermal elongation due to a local temperature rise of bearings and other reasons during operation, resulting in changes in machining dimensions. In addition, the vibration of the tool spindles in the milling process due to changes in the cutting force can also affect the machining accuracy. The existing compound machining tool power spindles also lack complete monitoring functions. Therefore, the manufacturers of turning and milling compound machine tools have been constantly improving the rigidity and intelligence level of the tool spindles. In Li Xiankai's paper on Key technologies of five-axis head for turning and milling compound machine tools, it is also mentioned that the position of the three-toothed-disk mechanism in the five-axis head for turning and milling has significant effect on the machining performance. How to prevent a spindle bearing from being impacted during tool releasing is a difficult problem for the five-axis head for turning and milling. In view of the above problem, the present invention adopts structural innovation such as a brand-new layout of the spindle bearing and a locking toothed disk and embedding of various sensors, which can meet all the requirements of turning and milling machining technologies for tool power spindles and have the characteristics of high rigidity and all-round digital detection and monitoring.

### SUMMARY

To solve the above problems in the prior art, the present invention proposes a novel spindle bearing layout structure, using a CAPTO standard tool interface, which can achieve high-rigidity connection between a tool and a spindle, and is very suitable for both turning and milling operating modes. A front bearing adopts a dual-row cylindrical roller bearing, a rear bearing adopts a three-row angular contact ball bearing, three locked toothed disks of a spindle are arranged near the rear bearing, and a flexible sleeve for assisting in locking the spindle is designed on the front end of the spindle. This is a rear-end positioned spindle support structure. The front bearing adopts the dual-row cylindrical roller bearing, and the three locked toothed disks of the spindle are arranged on the rear end. In this layout, the front bearing has very high radial stiffness, and the support position of the front bearing is as close as possible to a tool action point, which can ensure that the spindle can complete milling operation with high performance; the flexible sleeve for assisting in locking is also provided on the front end of the spindle, and the three locked toothed disks are arranged together with the ball bearing with weaker radial stiffness on the rear end, which avoids the over-positioning interference between the three locked toothed disks and the support bearing to the maximum extent, and is conducive to high-rigidity locking of the spindle during turning operation; and the three-toothed-disk mechanism is also provided with a positioning base surface, which can reduce the impact of a tool releasing piston on the spindle bearing during tool changing.

A high-rigidity turning and milling compound power tool spindle structure, wherein a spindle elongation mechanism comprises two parts: measuring a non-contact axial position change of a mechanical labyrinth flange that rotates together with the spindle by a distance sensor; and measuring an axial thermal displacement of a mounting part of the distance sensor by a contact displacement sensor and a thermal elongation detection rod. In this monitoring method, the local thermal deformation of parts such as a spindle box caused by a temperature rise of a bearing outer ring and the thermal elongation of a spindle core shaft caused by a temperature rise of a bearing inner ring are taken into account, and the thermal elongation between a spindle tool interface and a spindle box swing centerline can be directly reflected by integrating the measurement data of the two parts. A condition monitoring method for other aspects also comprises: arranging two radial distance sensors on the front end of the spindle to monitor a radial runout of the mechanical labyrinth flange in real time; continuously measuring the position of the tool releasing piston through a transmission mechanism such as a swing rod and a guide rod; monitoring the operating state of the flexible sleeve completing spindle locking and the operating state of the locking toothed disk in real time through the displacement sensor; and monitoring a temperature rise of the bearings through temperature sensors in direct contact with outer rings of the front and rear bearings.

The technical solution of the present invention is as follows:

A high-rigidity turning and milling compound power tool spindle structure, comprising the following structures:

A spindle box is cuboid and is provided with mounting flanges on an upper plane and a lower plane thereof, the rotation centerline of the mounting flanges is the spindle swing centerline, the mounting flanges are used for connecting a machine tool swing head and conducting interaction among mechanical, electrical and hydraulic pipelines, and the high-rigidity turning and milling compound power tool spindle structure can swing around the spindle swing centerline to perform multi-angle machining on a workpiece;

Both ends of a spindle core shaft are respectively installed in the spindle box through a front support bearing and a rear support bearing;

The front support bearing adopts a dual-row cylindrical roller bearing, with a taper of 1:12 in the diameter direction of an inner hole, and the axial position of the front support bearing on the spindle core shaft is determined by match grinding of a front bearing adjusting pad, making an inner ring of the front support bearing expand to eliminate the initial clearance, thereby achieving a designed preload and radial rigidity of the front support bearing;

The rear support bearing is composed of three angular contact ball bearings, among which, two angular contact ball bearings have the same contact angle direction to jointly resist an axial component force for milling, and the other angular contact ball bearing has an opposite contact angle direction and is spaced from the other two angular contact ball bearings through a bearing spacer; a preload of the rear support bearing is adjusted by match grinding of the bearing spacer; and an outer ring of the rear support bearing is pressed tightly in a mounting hole of the spindle box by a fixed toothed disk and a fixed toothed disk adjusting shim matched with the fixed toothed disk, an inner ring of the rear support bearing is fixed to the spindle core shaft by a rotating toothed disk as well as a rotating toothed disk adjusting shim and an axial locking adjusting shim matched with the rotating toothed disk, and axial positioning of the spindle core shaft is achieved through the rear support bearing;

A mechanical labyrinth flange and a tool interface flange are both installed on the front end of the spindle core shaft;

A hydraulic oil chamber locked and released by a three-toothed-disk mechanism is formed by a locking toothed disk, a spindle rear cylinder body and a sealing end cover; the three-toothed-disk mechanism is mainly composed of the fixed toothed disk, the rotating toothed disk and the locking toothed disk; the spindle rear cylinder body is installed on an end face of the fixed toothed disk, the sealing end cover is pressed tightly against an end face of an inner hole of the spindle rear cylinder body by a spindle rear cylinder head, the locking toothed disk is installed in the spindle rear cylinder body and can reciprocate under the action of oil pressure, the sealing end cover is installed on the front end of the spindle rear cylinder head, a guide cylindrical pin is fixed on an end face of the sealing end cover, and the spindle rear cylinder head is installed on an end face of the spindle rear cylinder body; and a tool releasing piston is installed in the spindle rear cylinder head and forms a tool releasing oil chamber through a sealing element;

A transmission bevel gear is installed on the spindle core shaft and conducts transmission through a flat key;

A broach mechanism is installed in an inner hole of the spindle core shaft, and a tool releasing flange is installed on the rear end of the broach mechanism;

The tool releasing flange is pushed under the action of oil pressure to load a tool into the broach mechanism; after the oil pressure is disconnected, a broach claw on the front end of the broach mechanism is driven by a nitrogen spring in the broach mechanism to lock the tool on the tool interface flange, and the spindle core shaft is driven by the transmission bevel gear through the flat key to rotate and start a milling operation; when the rotating toothed disk and the fixed toothed disk are driven by the spindle core shaft to achieve angular positioning, the locking toothed disk moves in the direction of the rotating toothed disk under the action of oil pressure in the spindle rear cylinder body and is guided by the guide cylindrical pin on the sealing end cover during moving to prevent circular rotation; under the action of the locking toothed disk, the rotating toothed disk is in close contact with a positioning base surface of the fixed toothed disk, tooth surfaces of the fixed toothed disk, the rotating toothed disk and the locking toothed disk are in full contact, and the three-toothed-disk mechanism completes locking; and the spindle core shaft is restricted by the rotating toothed disk and cannot rotate, and the high-rigidity turning and milling compound power tool spindle structure is switched to a turning operating mode;

A flexible conical surface locking mechanism is also provided on the front end of the spindle core shaft, a front locking cylinder body is installed on a front end face of the spindle box, a front sealing disk is installed on an end face of the front locking cylinder body, and a flexible locking sleeve reciprocates in the front locking cylinder body under the action of hydraulic oil; when the high-rigidity turning and milling compound power tool spindle structure is switched to the turning operating mode, the flexible conical surface locking mechanism begins to work, and a locking conical surface of the flexible locking sleeve is in close contact with an outer conical surface of the front part of the spindle core shaft to transmit a radial force acting on the front end of the spindle core shaft to the front locking cylinder body; and six notches are uniformly distributed on the locking conical surface of the flexible locking sleeve along the circumferential direction.

In the high-rigidity turning and milling compound power tool spindle structure, condition monitoring is conducted to a broach releasing process: the position of the tool releasing piston is continuously and digitally measured by a tool releasing displacement sensor, and a front end face of the tool releasing piston comes into contact with the tool releasing flange under the action of hydraulic oil to push the broach mechanism to complete a tool releasing action; a round head pin is tightened on the tool releasing piston, a swing rod is installed in the spindle rear cylinder head through a support shaft, one end of the swing rod is in close contact with the round head pin, a gear on the other end of the swing rod is meshed with a rack on one end of a guide rod, an angular positioning pin is installed on the other end of the guide rod, the angular positioning pin moves in a guide chute of a sensor mounting block, and the sensor mounting block is installed on a side surface of the spindle box; a cylindrical compression spring is installed on the guide rod through a spring washer and a lock nut, the cylindrical compression spring exerts a spring force on the swing rod through meshed tooth surfaces to ensure that the swing rod and the round head pin remain in close contact throughout the movement of the tool releasing piston, the moving position of the tool releasing piston is converted into a displacement of a detection plate installed on the guide rod, the detection plate is fixed to the guide rod through another lock nut, the detection plate is in contact with a spring-return detection rod in the tool releasing displacement sensor, and the tool releasing displacement sensor is installed on the sensor mounting block; and continuous measurement of the stroke of the tool releasing piston is indirectly achieved by measuring the moving position of the guide rod.

In the high-rigidity turning and milling compound power tool spindle structure, condition monitoring is conducted to the operating mode of the spindle core shaft: a locking toothed disk measuring bent plate is installed on the locking toothed disk, the locking toothed disk measuring bent plate is in contact with a spring-return detection rod in a toothed disk displacement sensor, and when the locking toothed disk moves in the spindle rear cylinder body, the position of the locking toothed disk is directly fed back by the toothed disk displacement sensor; and a locking sleeve measuring bent plate is installed on the flexible locking sleeve, the locking sleeve measuring bent plate is in contact with a spring-return detection rod in a locking sleeve displacement sensor, when the flexible locking sleeve moves in the front locking cylinder body, the position of the flexible locking sleeve is directly fed back by the locking sleeve displacement sensor, and the spindle core shaft is monitored to be in a turning or milling operating mode through the toothed disk displacement sensor and the locking sleeve displacement sensor.

In the high-rigidity turning and milling compound power tool spindle structure, condition monitoring is conducted to the thermal elongation of the spindle core shaft: a flange on the front fixed end of a thermal elongation detection rod is pressed tightly against the end face of the front locking cylinder body by the front sealing disk, the rear moving end of the thermal elongation detection rod is flush with the spindle swing centerline and is assistantly supported by the support seat 46, the support seat is installed on the side surface of the spindle box, an outer circle of the thermal elongation detection rod slides in inner holes of the front locking cylinder body and the support seat, when the front sealing disk undergoes a thermal displacement due to a local temperature rise of the high-rigidity turning and milling compound power tool spindle structure, the thermal elongation detection rod is also driven to move together, a distance change between the front sealing disk and the spindle swing centerline is measured by a contact displacement sensor in close contact with the rear moving end of the thermal elongation detection rod, a measuring head of the contact displacement sensor is always in contact with the rear moving end of the thermal elongation detection rod through a built-in return spring, and the contact displacement sensor is locked in the support seat; an axial distance sensor is fixed in a square groove of the front sealing disk through a sensor gland, and the sensor gland is installed on an end face of the front sealing disk; an axial displacement change of the mechanical labyrinth flange is directly measured by an eddy current probe in the axial distance sensor, the axial positions of the mechanical labyrinth flange and the tool interface flange are the same, and an axial displacement change between a tool mounting end face of the tool interface flange and the front sealing disk is obtained by monitoring the axial displacement change of the mechanical labyrinth flange; and a labyrinth clearance adjusting shim is arranged between the spindle core shaft and a mounting surface of the mechanical labyrinth flange and is used for adjusting the distance between the axial distance sensor and a corresponding measuring surface of the mechanical labyrinth flange, and a cable of the axial distance sensor passes through wire holes in the front locking cylinder body and the thermal elongation detection rod.

In the high-rigidity turning and milling compound power tool spindle structure, condition monitoring is conducted to the vibration of the spindle core shaft: two radial distance sensors are arranged in the front sealing disk at a circumferential interval of 90°, the radial distance sensors are pressed tightly in a V-shaped groove of the front sealing disk through sensor pressing blocks, and the sensor pressing blocks are fastened to the front sealing disk; and when the spindle core shaft rotates, a radial runout of a circumferential measuring surface of the mechanical labyrinth flange is measured in real time by eddy current probes in the radial distance sensors, a change in the rotational accuracy of the spindle core shaft is reflected by a measured value, and an excessive displacement of the mechanical labyrinth flange caused by an accidental collision of the tool is monitored by the measurement data from the two radial distance sensors and the axial distance sensor.

In the high-rigidity turning and milling compound power tool spindle structure, condition monitoring is conducted to temperature rises of the front support bearing and the rear support bearing: temperature sensor mounting holes are machined at the front support bearing and the rear support bearing in the spindle box, a front bearing temperature sensor is tightened in a temperature sensor mounting hole through own threads, and a measuring head thereof is in direct contact with an outer ring of the front support bearing; and a rear bearing temperature sensor is tightened in a temperature sensor mounting hole through own threads, and a measuring head thereof is in direct contact with an outer ring of one angular contact ball bearing in the rear support bearing to monitor a temperature change in the bearing in real time during the operation of the spindle.

The present invention has the following beneficial effects:
1. The present invention proposes a rear-end positioning bearing layout structure for a turning and milling compound machining power tool spindle. Bearings that undertake radial support and axial positioning are arranged in tandem, and preloads of the bearings are adjusted respectively by match grinding of adjusting pads, which can simultaneously meet the requirements of high-rigidity milling and turning machining.
2. The CAPTO standard structure is adopted as the tool interface form, ensuring the high-rigidity positioning of the tool tip during turning machining.
3. The position information of the tool releasing piston, the locking toothed disk and the flexible locking sleeve in the key actions of tool changing and spindle locking is continuously monitored by the displacement sensors and directly output in a digital form, which improves the reliability of spindle operation.
4. The three locked toothed disks of the spindle are arranged on the rear end, reducing the adverse effect of spindle thermal elongation on the locking stiffness of the tooth surfaces. The positioning base surface is added between the rotating toothed disk and the fixed toothed disk, eliminating the impact of a tool releasing force on the spindle bearing.
5. The flexible locking sleeve is arranged on the front end of the spindle, and six undercuts are uniformly distributed on the locking sleeve along the circumferential direction, further enhancing the radial stiffness of the spindle during turning.
6. Real-time monitoring of spindle thermal elongation, bearing operating condition, cutting vibration and unexpected collision are achieved by embedding a variety of sensors.

### DESCRIPTION OF DRAWINGS

FIG. 1 is a main view of a turning and milling compound spindle.

FIG. 2 is a rear view of a turning and milling compound spindle.

FIG. 3 is an A-A sectional view of a turning and milling compound spindle in FIG. 1.

FIG. 4 is a local view of a turning and milling compound spindle I in FIG. 3.

FIG. 5 is a B-B sectional view of a turning and milling compound spindle in FIG. 2.

FIG. 6 is a C-C sectional view of a turning and milling compound spindle in FIG. 2.

FIG. 7 is a D-D sectional view of a turning and milling compound spindle in FIG. 1.

FIG. 8 is an F-F (G-G) sectional view of a turning and milling compound spindle in FIG. 1.

FIG. 9 is a left view of a turning and milling compound spindle.

FIG. 10 is a local view of a turning and milling compound spindle II in FIG. 9.

In the figures: 1 spindle box; 2 spindle core shaft; 3 front support bearing; 4 rear support bearing; 5 mechanical labyrinth flange; 6 tool interface flange; 7 front bearing adjusting pad; 8 broach mechanism; 9 bearing spacer; 10 rotating toothed disk adjusting shim; 11 fixed toothed disk adjusting shim; 12 fixed toothed disk; 13 rotating toothed disk; 14 axial locking adjusting shim; 15 locking toothed disk; 16 spindle rear cylinder body; 17 spindle rear cylinder head; 18 tool releasing piston; 19 sealing end cover; 20 tool releasing flange; 21 transmission bevel gear; 22 flat key; 23 flexible locking sleeve; 24 front locking cylinder body; 25 front sealing disk; 26 guide cylindrical pin; 27 round head pin; 28 swing rod; 29 support shaft; 30 guide rod; 31 cylindrical compression spring; 32 washer; 33 lock nut; 34 angular positioning pin; 35 detection plate; 36 tool releasing displacement sensor; 37 sensor mounting block; 38 locking toothed disk measuring bent plate; 39 toothed disk displacement sensor; 40 locking sleeve displacement sensor; 41 locking sleeve measuring bent plate; 42 labyrinth clearance adjusting shim; 43 axial distance sensor; 44 sensor gland; 45 thermal elongation detection rod; 46 support seat; 47 contact displacement sensor; 48 radial distance sensor; 49 sensor pressing block; 50 rear bearing temperature sensor; and 51 front bearing temperature sensor.

### DETAILED DESCRIPTION

Detailed description of the present invention is described below in detail in combination with drawings and the technical solution.

A high-rigidity turning and milling compound power tool spindle structure has the following specific structure:

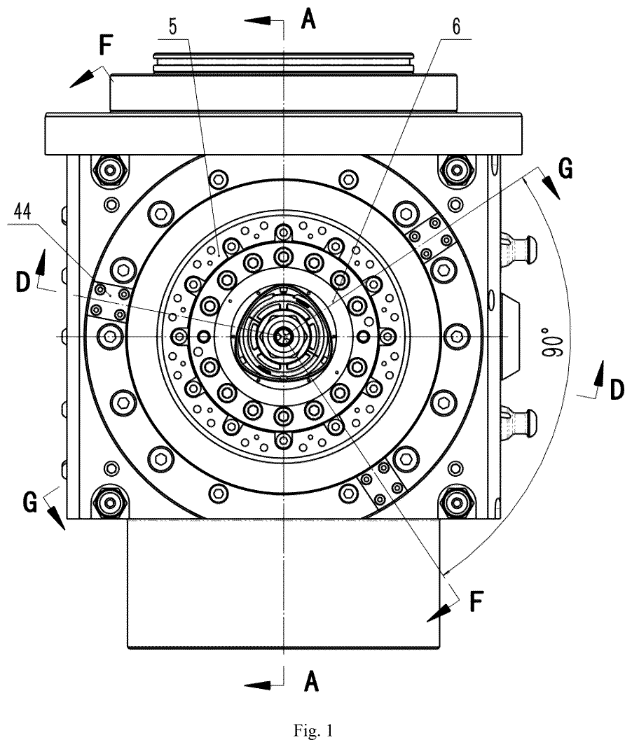

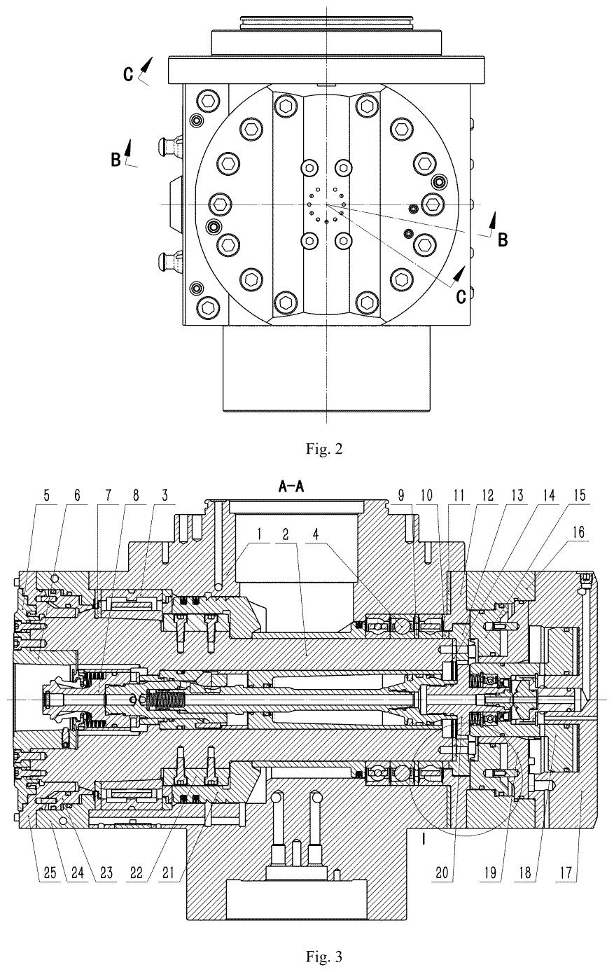

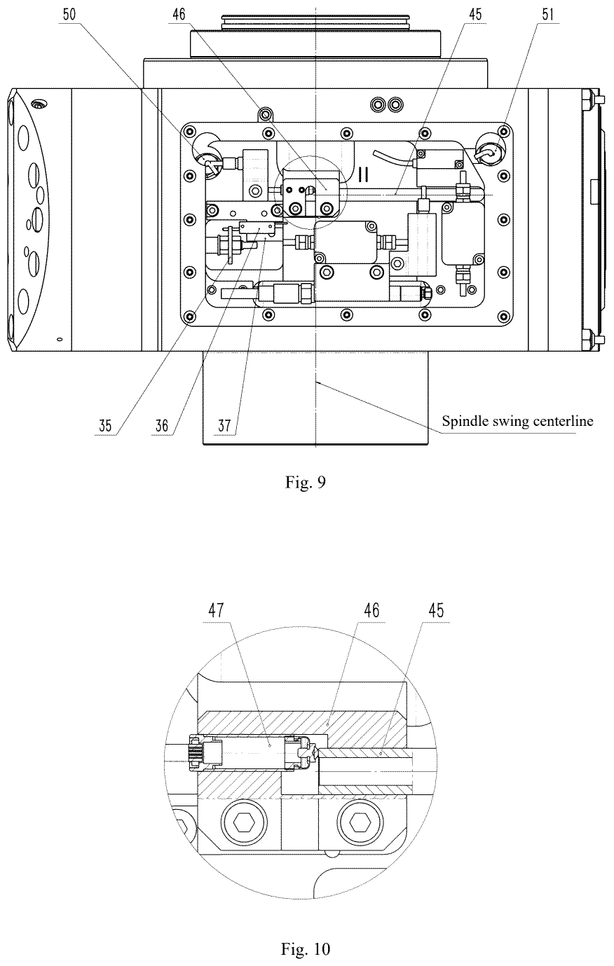

FIG. 1, FIG. 2 and FIG. 9 are outside views of a high-rigidity turning and milling compound power tool spindle structure. A spindle box 1 is cuboid and is provided with mounting flanges on an upper plane and a lower plane thereof, the rotation centerline of the mounting flanges is the spindle swing centerline, the mounting flanges are used for connecting a machine tool swing head and conducting interaction among mechanical, electrical and hydraulic pipelines, and the high-rigidity turning and milling compound power tool spindle structure can swing around the spindle swing centerline to perform multi-angle machining on a workpiece;

As shown in FIG. 3, both ends of a spindle core shaft 2 are respectively installed in the spindle box 1 through a front support bearing 3 and a rear support bearing 4; the front support bearing 3 adopts a dual-row cylindrical roller bearing, with a taper of 1:12 in the diameter direction of an inner hole, and the axial position of the front support bearing 3 on the spindle core shaft 2 is determined by match grinding of a front bearing adjusting pad 7, making an inner ring of the front support bearing 3 expand to eliminate the initial clearance, thereby achieving a designed preload and radial rigidity of the front support bearing 3; the rear support bearing 4 is composed of three angular contact ball bearings, among which, two angular contact ball bearings have the same contact angle direction to jointly resist an axial component force for milling, and the other angular contact ball bearing has an opposite contact angle direction and is spaced from the other two angular contact ball bearings through a bearing spacer 9; a preload of the rear support bearing 4 is adjusted by match grinding of the bearing spacer 9; an outer ring of the rear support bearing 4 is pressed tightly in a mounting hole of the spindle box 1 by a fixed toothed disk 12 and a fixed toothed disk adjusting shim 11 matched with the fixed toothed disk 12, an inner ring of the rear support bearing 4 is fixed to the spindle core shaft 2 by a rotating toothed disk 13 as well as a rotating toothed disk adjusting shim 10 and an axial locking adjusting shim 14 matched with the rotating toothed disk 13, and axial positioning of the spindle core shaft 2 is achieved through the rear support bearing 4; and a mechanical labyrinth flange 5 and a tool interface flange 6 are both installed on the front end of the spindle core shaft 2;

A hydraulic oil chamber locked and released by a three-toothed-disk mechanism is formed by a locking toothed disk 15, a spindle rear cylinder body 16 and a sealing end cover 19; the three-toothed-disk mechanism is mainly composed of the fixed toothed disk 12, the rotating toothed disk 13 and the locking toothed disk 15; the spindle rear cylinder body 16 is installed on an end face of the fixed toothed disk 12, the sealing end cover 19 is pressed tightly against an end face of an inner hole of the spindle rear cylinder body 16 by a spindle rear cylinder head 17, the locking toothed disk 15 is installed in the spindle rear cylinder body 16 and can reciprocate under the action of oil pressure, the sealing end cover 19 is installed on the front end of the spindle rear cylinder head 17, a guide cylindrical pin 26 is fixed on an end face of the sealing end cover 19, and the spindle rear cylinder head 17 is installed on an end face of the spindle rear cylinder body 16; and a tool releasing piston 18 is installed in the spindle rear cylinder head 17 and forms a tool releasing oil chamber through a sealing element;

A transmission bevel gear 21 is installed on the spindle core shaft 2 and conducts transmission through a flat key 22;

A broach mechanism 8 is installed in an inner hole of the spindle core shaft 2, and a tool releasing flange 20 is installed on the rear end of the broach mechanism 8;

The tool releasing flange 20 is pushed under the action of oil pressure to load a tool into the broach mechanism 8; after the oil pressure is disconnected, a broach claw on the front end of the broach mechanism 8 is driven by a nitrogen spring in the broach mechanism 8 to lock the tool on the tool interface flange 6, and the spindle core shaft 2 is driven by the transmission bevel gear 21 through the flat key 22 to rotate and start a milling operation; when the rotating toothed disk 13 and the fixed toothed disk 12 are driven by the spindle core shaft 2 to achieve angular positioning, the locking toothed disk 15 moves in the direction of the rotating toothed disk 13 under the action of oil pressure in the spindle rear cylinder body 16 and is guided by the guide cylindrical pin 26 on the sealing end cover 19 during moving to prevent circular rotation; under the action of the locking toothed disk 15, the rotating toothed disk 13 is in close contact with a positioning base surface of the fixed toothed disk 12, tooth surfaces of the fixed toothed disk 12, the rotating toothed disk 13 and the locking toothed disk 15 are in full contact, and the three-toothed-disk mechanism completes locking; and the spindle core shaft 2 is restricted by the rotating toothed disk 13 and cannot rotate, and the high-rigidity turning and milling compound power tool spindle structure is switched to a turning operating mode;

A flexible conical surface locking mechanism is also provided on the front end of the spindle core shaft 2, a front locking cylinder body 24 is installed on a front end face of the spindle box 1, a front sealing disk 25 is installed on an end face of the front locking cylinder body 24, and a flexible locking sleeve 23 reciprocates in the front locking cylinder body 24 under the action of hydraulic oil; when the high-rigidity turning and milling compound power tool spindle structure is switched to the turning operating mode, the flexible conical surface locking mechanism begins to work, and a locking conical surface of the flexible locking sleeve 23 is in close contact with an outer conical surface of the front part of the spindle core shaft 2 to transmit a radial force acting on the front end of the spindle core shaft 2 to the front locking cylinder body 24; and six notches are uniformly distributed on the locking conical surface of the flexible locking sleeve 23 along the circumferential direction.

When the spindle support bearings rotate at a high speed, heat will be generated. The heat will cause a local temperature rise of the parts such as the spindle core shaft 2 and the spindle box 1, resulting in a change in the axial distance between the tool interface flange 6 and the spindle swing centerline, and affecting the machining accuracy. Therefore, it is necessary to monitor the spindle thermal elongation state. Referring to FIG. 1, FIG. 7, FIG. 9 and FIG. 10, a specific implementation method is as follows: in the high-rigidity turning and milling compound power tool spindle structure, condition monitoring is conducted to the thermal elongation of the spindle core shaft 2: a flange on the front fixed end of a thermal elongation detection rod 45 is pressed tightly against the end face of the front locking cylinder body 24 by the front sealing disk 25, the rear moving end of the thermal elongation detection rod 45 is flush with the spindle swing centerline and is assistantly supported by the support seat 46, the support seat 46 is installed on a side surface of the spindle box 1, an outer circle of the thermal elongation detection rod 45 slides in inner holes of the front locking cylinder body 24 and the support seat 46, when the front sealing disk 25 undergoes a thermal displacement due to a local temperature rise of the high-rigidity turning and milling compound power tool spindle structure, the thermal elongation detection rod 45 is also driven to move together, a distance change between the front sealing disk 25 and the spindle swing centerline is measured by a contact displacement sensor 47 in close contact with the rear moving end of the thermal elongation detection rod 45, a measuring head of the contact displacement sensor 47 is always in contact with the rear moving end of the thermal elongation detection rod 45 through a built-in return spring, and the contact displacement sensor 47 is locked in the support seat 46; an axial distance sensor 43 is fixed in a square groove of the front sealing disk 25 through a sensor gland 44, and the sensor gland 44 is installed on an end face of the front sealing disk 25; an axial displacement change of the mechanical labyrinth flange 5 is directly measured by an eddy current probe in the axial distance sensor 43, the axial positions of the mechanical labyrinth flange 5 and the tool interface flange 6 are the same, and an axial displacement change between a tool mounting end face of the tool interface flange 6 and the front sealing disk 25 is obtained by monitoring the axial displacement change of the mechanical labyrinth flange 5; and a labyrinth clearance adjusting shim 42 is arranged between the spindle core shaft 2 and a mounting surface of the mechanical labyrinth flange 5 and is used for adjusting the distance between the axial distance sensor 43 and a corresponding measuring surface of the mechanical labyrinth flange 5, and a cable of the axial distance sensor 43 passes through wire holes in the front locking cylinder body 24 and the thermal elongation detection rod 45. When the spindle structure operates at a high speed and the local temperature rise is caused by the heat of the bearings, the temperature fields of the parts such as the spindle box 1 and the spindle core shaft 2 are all changed in real time, and an axial position change of the tool interface flange 6 for installing the tool can be monitored in real time based on the results of the above measurements.

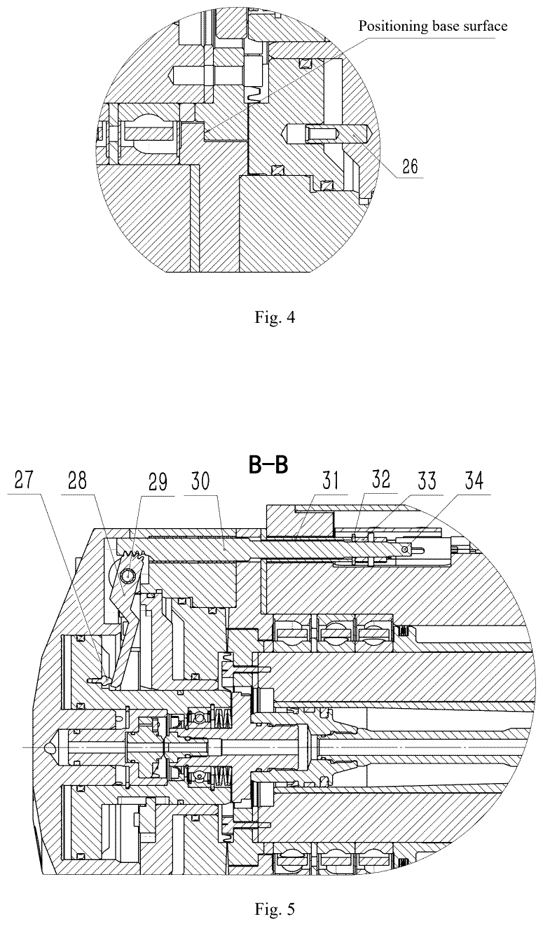

A turning and milling compound power tool spindle not only needs to rotate at a high speed for a milling operation, but also needs to have the capability for a turning operation. In this case, the spindle shall be locked to ensure that a cutting force on a turning tool can be transmitted to the spindle box 1 without any gap, which includes two crucial locking links: the first is the connection between the tool and the spindle core shaft 2, wherein the spindle structure adopts a CAPTO standard connection mode, which achieves backlash-free connection in the rotation direction of the tool. The second is the high-rigidity locking between the spindle core shaft 2 and the spindle box 1; the present invention adopts the three-toothed-disk mechanism which is provided with the positioning base surface and is arranged on the fixed end of the spindle; such arrangement, in one aspect, reduces the axial position change of the rotating toothed disk 13 caused by spindle thermal elongation, and in another aspect, weakens the excessive positioning interference caused by the non-concentricity of the three toothed disks and the spindle support bearings during locking; both improvements in the tow aspects can enhance the locking rigidity of the three toothed disks. The three-toothed-disk mechanism in the present invention is provided with the positioning base surface, and the machining of the tooth surfaces of the rotating toothed disk 13 and the fixed toothed disk 12 is carried out by grinding in groups with the positioning base surface as a process reference. Referring to FIG. 3 and FIG. 4, a specific implementation method is as follows: first, match grinding is conducted to the fixed toothed disk adjusting shim 11 to ensure that the fixed toothed disk 12 can be pressed tightly against an outer ring of the support bearing on the rear end of the spindle, the fixed toothed disk adjusting shim 11 and the fixed toothed disk 12 are installed together on a rear end face of the spindle box 1 with screws, and attention is paid to the angular position of the fixed toothed disk 12 during assembling; and then match grinding is conducted to the rotating toothed disk adjusting shim 10 and the axial locking adjusting shim 14 to ensure that the positioning base surfaces of the fixed toothed disk 12 and the rotating toothed disk 13 maintain a gap of 0.02-0.03 mm in a milling operating mode, the rotating toothed disk 13 and the axial locking adjusting shim 14 are locked on a rear end face of the spindle core shaft 2 by screws, and at the same time, an inner ring of the support bearing on the rear end of the spindle is also pre-tightened. The hydraulic oil chamber locked and released by the three-toothed-disk mechanism is formed by the locking toothed disk 15, the spindle rear cylinder body 16 and the sealing end cover 19, and the locking toothed disk 15 moves in the spindle rear cylinder body 16 under the action of oil pressure and is guided by the guide cylindrical pin 26 on the sealing end cover 19 during moving to prevent the phenomenon of tooth butting when the toothed disk is locked. When the three-toothed-disk mechanism is locked, the locking toothed disk 15 moves and first comes into contact with the tooth surface of the rotating toothed disk 13, then the locking toothed disk 15 is further pushed to move towards the fixed toothed disk 12 until the positioning base surfaces of the rotating toothed disk 13 and the fixed toothed disk 12 are completely in close contact, so that all degrees of freedom of the rotating toothed disk 13 are restricted, a locking force of the locking toothed disk 15 is relatively evenly distributed to the tooth surfaces of the rotating toothed disk 13 and the fixed toothed disk 12, and the overall locking rigidity of the three-toothed-disk mechanism is extremely high. At this time, an impact force acting on the spindle core shaft 2 when the tool is released will also be resisted by the locked three-toothed-disk mechanism, which is conducive to maintaining the accuracy of the spindle support bearings.

In order to further enhance the locking rigidity of the spindle in the turning operating mode, the front end of the spindle is provided with an auxiliary locking mechanism. Referring to FIG. 3, an implementation method thereof is that a locking conical surface is machined at the front part of the spindle core shaft, the flexible locking sleeve 23 reciprocates in the front locking cylinder body 24 under the action of hydraulic oil, and the locking conical surface of the flexible locking sleeve 23 is in close contact with the outer conical surface of the front part of the spindle core shaft 2, so that a radial force acting on the front end of the spindle core shaft 2 can be transmitted to the front locking cylinder body 24 through the locking conical surface of the flexible locking sleeve 23. In addition, as a coaxiality error exists between the above-mentioned locking conical surface and the front support bearing 3 of the spindle, six notches are uniformly machined on the locking conical surface of the flexible locking sleeve 23 along the circumferential direction, so that the contact rate with the locking conical surface is increased.

In the high-rigidity turning and milling compound power tool spindle structure, condition monitoring is conducted to a broach releasing process, and a relevant implementation method is as follows:

Condition monitoring is conducted to a broach releasing process, as shown in FIG. 5 and FIG. 9. The position of the tool releasing piston 18 is continuously and digitally measured by a tool releasing displacement sensor 36, and a front end face of the tool releasing piston 18 comes into contact with the tool releasing flange 20 under the action of hydraulic oil to push the broach mechanism 8 to complete a tool releasing action; a round head pin 27 is tightened on the tool releasing piston 18, a swing rod 28 is installed in the spindle rear cylinder head 17 through a support shaft 29, one end of the swing rod 28 is in close contact with the round head pin 27, a gear on the other end of the swing rod 28 is meshed with a rack on one end of a guide rod 30, an angular positioning pin 34 is installed on the other end of the guide rod 30, the angular positioning pin 34 moves in a guide chute of a sensor mounting block 37, and the sensor mounting block 37 is installed on the side surface of the spindle box 1; a cylindrical compression spring 31 is installed on the guide rod 30 through a spring washer 32 and a lock nut 33, the cylindrical compression spring 31 exerts a spring force on the swing rod 28 through meshed tooth surfaces to ensure that the swing rod 28 and the round head pin 27 remain in close contact throughout the movement of the tool releasing piston 18, the moving position of the tool releasing piston 18 is converted into a displacement of a detection plate 35 installed on the guide rod 30, the detection plate 35 is fixed to the guide rod 30 through another lock nut 33, the detection plate 35 is in contact with a spring-return detection rod in the tool releasing displacement sensor 36, and the tool releasing displacement sensor 36 is installed on the sensor mounting block 37; and continuous measurement of the stroke of the tool releasing piston 18 is indirectly achieved by measuring the moving position of the guide rod 30.

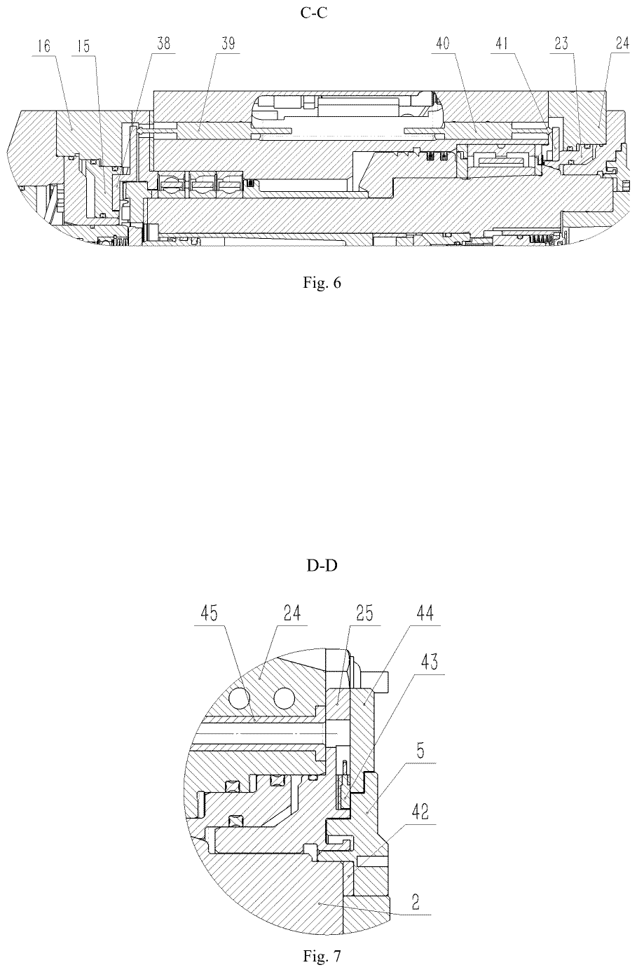

In the high-rigidity turning and milling compound power tool spindle structure, condition monitoring is conducted to the operating mode of the spindle core shaft 2: referring to FIG. 6, a locking toothed disk measuring bent plate 38 is installed on the locking toothed disk 15, the locking toothed disk measuring bent plate 38 is in contact with a spring-return detection rod in a toothed disk displacement sensor 39, and when the locking toothed disk 15 moves in the spindle rear cylinder body 16, the position of the locking toothed disk 15 is directly fed back by the toothed disk displacement sensor 39; and a locking sleeve measuring bent plate 41 is installed on the flexible locking sleeve 23, the locking sleeve measuring bent plate 41 is in contact with a spring-return detection rod in a locking sleeve displacement sensor 40, when the flexible locking sleeve 23 moves in the front locking cylinder body 24, the position of the flexible locking sleeve 23 is directly fed back by the locking sleeve displacement sensor 40, and the spindle core shaft 2 is monitored to be in a turning or milling operating mode through the toothed disk displacement sensor 39 and the locking sleeve displacement sensor 40.

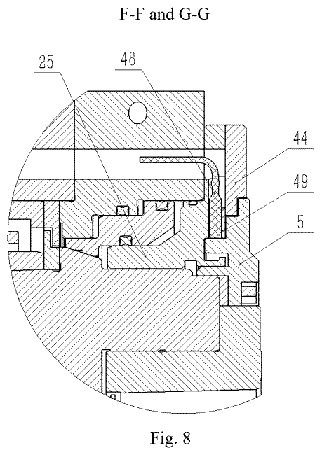

In the high-rigidity turning and milling compound power tool spindle structure, condition monitoring is conducted to the vibration of the spindle core shaft 2: referring to FIG. 1 and FIG. 8, as a monitored object rotates at a high speed, a non-contact distance sensor is selected. Two radial distance sensors 48 are arranged in the front sealing disk 25 at a circumferential interval of 90°, the radial distance sensors 48 are pressed tightly in a V-shaped groove of the front sealing disk 25 through sensor pressing blocks 49, and the sensor pressing blocks 49 are fastened to the front sealing disk 25; and when the spindle core shaft 2 rotates, a radial runout of a circumferential measuring surface of the mechanical labyrinth flange 5 is measured in real time by eddy current probes in the radial distance sensors 48, a change in the rotational accuracy of the spindle core shaft 2 is reflected by a measured value, and an excessive displacement of the mechanical labyrinth flange 5 caused by an accidental collision of the tool is monitored by the measurement data from the two radial distance sensors 48 and the axial distance sensor 43.

In the high-rigidity turning and milling compound power tool spindle structure, condition monitoring is conducted to temperature rises of the front support bearing 3 and the rear support bearing 4: referring to FIG. 9, temperature sensor mounting holes are machined at the front support bearing 3 and the rear support bearing 4 in the spindle box 1, a front bearing temperature sensor 51 is tightened in a temperature sensor mounting hole through own threads, and a measuring head thereof is in direct contact with an outer ring of the front support bearing 3; and a rear bearing temperature sensor 50 is tightened in a temperature sensor mounting hole through own threads, and a measuring head thereof is in direct contact with an outer ring of one angular contact ball bearing in the rear support bearing 4 to monitor a temperature change in the bearing in real time during the operation of the spindle.

1. A high-rigidity turning and milling compound power tool spindle structure, comprising the following structures:
a spindle box (1) is cuboid and is provided with mounting flanges on an upper plane and a lower plane thereof, the rotation centerline of the mounting flanges is the spindle swing centerline, the mounting flanges are used for connecting a machine tool swing head and conducting interaction among mechanical, electrical and hydraulic pipelines, and the high-rigidity turning and milling compound power tool spindle structure can swing around the spindle swing centerline to perform multi-angle machining on a workpiece;
both ends of a spindle core shaft (2) are respectively installed in the spindle box (1) through a front support bearing (3) and a rear support bearing (4);
the front support bearing (3) adopts a dual-row cylindrical roller bearing, with a taper of 1:12 in the diameter direction of an inner hole, and the axial position of the front support bearing (3) on the spindle core shaft (2) is determined by match grinding of a front bearing adjusting pad (7), making an inner ring of the front support bearing (3) expand to eliminate the initial clearance, thereby achieving a designed preload and radial rigidity of the front support bearing (3);
the rear support bearing (4) is composed of three angular contact ball bearings, among which, two angular contact ball bearings have the same contact angle direction to jointly resist an axial component force for milling, and the other angular contact ball bearing has an opposite contact angle direction and is spaced from the other two angular contact ball bearings through a bearing spacer (9); a preload of the rear support bearing (4) is adjusted by match grinding of the bearing spacer (9); and an outer ring of the rear support bearing (4) is pressed tightly in a mounting hole of the spindle box (1) by a fixed toothed disk (12) and a fixed toothed disk adjusting shim (11) matched with the fixed toothed disk (12), an inner ring of the rear support bearing (4) is fixed to the spindle core shaft (2) by a rotating toothed disk (13) as well as a rotating toothed disk adjusting shim (10) and an axial locking adjusting shim (14) matched with the rotating toothed disk (13), and axial positioning of the spindle core shaft (2) is achieved through the rear support bearing (4);
a mechanical labyrinth flange (5) and a tool interface flange (6) are both installed on the front end of the spindle core shaft (2);
a hydraulic oil chamber locked and released by a three-toothed-disk mechanism is formed by a locking toothed disk (15), a spindle rear cylinder body (16) and a sealing end cover (19); the three-toothed-disk mechanism is mainly composed of the fixed toothed disk (12), the rotating toothed disk (13) and the locking toothed disk (15); the spindle rear cylinder body (16) is installed on an end face of the fixed toothed disk (12), the sealing end cover (19) is pressed tightly against an end face of an inner hole of the spindle rear cylinder body (16) by a spindle rear cylinder head (17), the locking toothed disk (15) is installed in the spindle rear cylinder body (16) and can reciprocate under the action of oil pressure, the sealing end cover (19) is installed on the front end of the spindle rear cylinder head (17), a guide cylindrical pin (26) is fixed on an end face of the sealing end cover (19), and the spindle rear cylinder head (17) is installed on an end face of the spindle rear cylinder body (16); and a tool releasing piston (18) is installed in the spindle rear cylinder head (17) and forms a tool releasing oil chamber through a sealing element;
a transmission bevel gear (21) is installed on the spindle core shaft (2) and conducts transmission through a flat key (22);
a broach mechanism (8) is installed in an inner hole of the spindle core shaft (2), and a tool releasing flange (20) is installed on the rear end of the broach mechanism (8);
the tool releasing flange (20) is pushed under the action of oil pressure to load a tool into the broach mechanism (8); after the oil pressure is disconnected, a broach claw on the front end of the broach mechanism (8) is driven by a nitrogen spring in the broach mechanism (8) to lock the tool on the tool interface flange (6), and the spindle core shaft (2) is driven by the transmission bevel gear (21) through the flat key (22) to rotate and start a milling operation; when the rotating toothed disk (13) and the fixed toothed disk (12) are driven by the spindle core shaft (2) to achieve angular positioning, the locking toothed disk (15) moves in the direction of the rotating toothed disk (13) under the action of oil pressure in the spindle rear cylinder body (16) and is guided by the guide cylindrical pin (26) on the sealing end cover (19) during moving to prevent circular rotation; under the action of the locking toothed disk (15), the rotating toothed disk (13) is in close contact with a positioning base surface of the fixed toothed disk (12), tooth surfaces of the fixed toothed disk (12), the rotating toothed disk (13) and the locking toothed disk (15) are in full contact, and the three-toothed-disk mechanism completes locking; and the spindle core shaft (2) is restricted by the rotating toothed disk (13) and cannot rotate, and the high-rigidity turning and milling compound power tool spindle structure is switched to a turning operating mode;
a flexible conical surface locking mechanism is also provided on the front end of the spindle core shaft (2), a front locking cylinder body (24) is installed on a front end face of the spindle box (1), a front sealing disk (25) is installed on an end face of the front locking cylinder body (24), and a flexible locking sleeve (23) reciprocates in the front locking cylinder body (24) under the action of hydraulic oil; when the high-rigidity turning and milling compound power tool spindle structure is switched to the turning operating mode, the flexible conical surface locking mechanism begins to work, and a locking conical surface of the flexible locking sleeve (23) is in close contact with an outer conical surface of the front part of the spindle core shaft (2) to transmit a radial force acting on the front end of the spindle core shaft (2) to the front locking cylinder body (24); and six notches are uniformly distributed on the locking conical surface of the flexible locking sleeve (23) along the circumferential direction.

2. The high-rigidity turning and milling compound power tool spindle structure according to claim 1, wherein
in the high-rigidity turning and milling compound power tool spindle structure, condition monitoring is conducted to a broach releasing process: the position of the tool releasing piston (18) is continuously and digitally measured by a tool releasing displacement sensor (36), and a front end face of the tool releasing piston (18) comes into contact with the tool releasing flange (20) under the action of hydraulic oil to push the broach mechanism (8) to complete a tool releasing action; a round head pin (27) is tightened on the tool releasing piston (18), a swing rod (28) is installed in the spindle rear cylinder head (17) through a support shaft (29), one end of the swing rod (28) is in close contact with the round head pin (27), a gear on the other end of the swing rod (28) is meshed with a rack on one end of a guide rod (30), an angular positioning pin (34) is installed on the other end of the guide rod (30), the angular positioning pin (34) moves in a guide chute of a sensor mounting block (37), and the sensor mounting block (37) is installed on a side surface of the spindle box (1); a cylindrical compression spring (31) is installed on the guide rod (30) through a spring washer (32) and a lock nut (33), the cylindrical compression spring (31) exerts a spring force on the swing rod (28) through meshed tooth surfaces to ensure that the swing rod (28) and the round head pin (27) remain in close contact throughout the movement of the tool releasing piston (18), the moving position of the tool releasing piston (18) is converted into a displacement of a detection plate (35) installed on the guide rod (30), the detection plate (35) is fixed to the guide rod (30) through another lock nut (33), the detection plate (35) is in contact with a spring-return detection rod in the tool releasing displacement sensor (36), and the tool releasing displacement sensor (36) is installed on the sensor mounting block (37); and continuous measurement of the stroke of the tool releasing piston (18) is indirectly achieved by measuring the moving position of the guide rod (30).

3. The high-rigidity turning and milling compound power tool spindle structure according to claim 1, wherein
in the high-rigidity turning and milling compound power tool spindle structure, condition monitoring is conducted to the operating mode of the spindle core shaft (2): a locking toothed disk measuring bent plate (38) is installed on the locking toothed disk (15), the locking toothed disk measuring bent plate (38) is in contact with a spring-return detection rod in a toothed disk displacement sensor (39), and when the locking toothed disk (15) moves in the spindle rear cylinder body (16), the position of the locking toothed disk (15) is directly fed back by the toothed disk displacement sensor (39); and a locking sleeve measuring bent plate (41) is installed on the flexible locking sleeve (23), the locking sleeve measuring bent plate (41) is in contact with a spring-return detection rod in a locking sleeve displacement sensor (40), when the flexible locking sleeve (23) moves in the front locking cylinder body (24), the position of the flexible locking sleeve (23) is directly fed back by the locking sleeve displacement sensor (40), and the spindle core shaft (2) is monitored to be in a turning or milling operating mode through the toothed disk displacement sensor (39) and the locking sleeve displacement sensor (40).

4. The high-rigidity turning and milling compound power tool spindle structure according to claim 1, wherein
in the high-rigidity turning and milling compound power tool spindle structure, condition monitoring is conducted to the thermal elongation of the spindle core shaft (2): a flange on the front fixed end of a thermal elongation detection rod (45) is pressed against the end face of the front locking cylinder body (24) by the front sealing disk (25), the rear moving end of the thermal elongation detection rod (45) is flush with the spindle swing centerline and is assistantly supported by the support seat (46), the support seat (46) is installed on the side surface of the spindle box (1), an outer circle of the thermal elongation detection rod (45) slides in inner holes of the front locking cylinder body (24) and the support seat (46), when the front sealing disk (25) undergoes a thermal displacement due to a local temperature rise of the high-rigidity turning and milling compound power tool spindle structure, the thermal elongation detection rod (45) is also driven to move together, a distance change between the front sealing disk (25) and the spindle swing centerline is measured by a contact displacement sensor (47) in close contact with the rear moving end of the thermal elongation detection rod (45), a measuring head of the contact displacement sensor (47) is always in contact with the rear moving end of the thermal elongation detection rod (45) through a built-in return spring, and the contact displacement sensor (47) is locked in the support seat (46); an axial distance sensor (43) is fixed in a square groove of the front sealing disk (25) through a sensor gland (44), and the sensor gland is installed on an end face of the front sealing disk (25); an axial displacement change of the mechanical labyrinth flange (5) is directly measured by an eddy current probe in the axial distance sensor (43), the axial positions of the mechanical labyrinth flange (5) and the tool interface flange (6) are the same, and an axial displacement change between a tool mounting end face of the tool interface flange (6) and the front sealing disk (25) is obtained by monitoring the axial displacement change of the mechanical labyrinth flange (5); and a labyrinth clearance adjusting shim (42) is arranged between the spindle core shaft (2) and a mounting surface of the mechanical labyrinth flange (5) and is used for adjusting the distance between the axial distance sensor (43) and a corresponding measuring surface of the mechanical labyrinth flange (5), and a cable of the axial distance sensor (43) passes through wire holes in the front locking cylinder body (24) and the thermal elongation detection rod (45).

5. The high-rigidity turning and milling compound power tool spindle structure according to claim 1, wherein
in the high-rigidity turning and milling compound power tool spindle structure, condition monitoring is conducted to the vibration of the spindle core shaft (2): two radial distance sensors (48) are arranged in the front sealing disk (25) at a circumferential interval of 90°, the radial distance sensors (48) are pressed tightly in a V-shaped groove of the front sealing disk (25) through sensor pressing blocks (49), and the sensor pressing blocks (49) are fastened to the front sealing disk (25); and when the spindle core shaft (2) rotates, a radial runout of an upper circumferential measuring surface of the mechanical labyrinth flange (5) is measured in real time by eddy current probes in the radial distance sensors (48), a change in the rotational accuracy of the spindle core shaft (2) is reflected by a measured value, and an excessive displacement of the mechanical labyrinth flange (5) caused by an accidental collision of the tool is monitored by the measurement data from the two radial distance sensors (48) and the axial distance sensor (43).

6. The high-rigidity turning and milling compound power tool spindle structure according to claim 1, wherein
in the high-rigidity turning and milling compound power tool spindle structure, condition monitoring is conducted to temperature rises of the front support bearing (3) and the rear support bearing (4): temperature sensor mounting holes are machined at the front support bearing (3) and the rear support bearing (4) in the spindle box (1), a front bearing temperature sensor (51) is tightened in a temperature sensor mounting hole through own threads, and a measuring head thereof is in direct contact with an outer ring of the front support bearing (3); and a rear bearing temperature sensor (50) is tightened in a temperature sensor mounting hole through own threads, and a measuring head thereof is in direct contact with an outer ring of one angular contact ball bearing in the rear support bearing (4) to monitor a temperature change in the bearing in real time during the operation of the spindle.
